(19) United States
(12) Patent Application Publication
(10) Pub. No.: US 2004/0213248 A1
(43) Pub. Date: Oct. 28, 2004

(54) Method and apparatus for transmitting a cell and a packet in a network

(76) Inventors: Masato Okuda, Kawasaki (JP); Jun Tanaka, Kawasaki (JP); Michio Kusayanagi, Kawasaki (JP); Kazuto Nishimura, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/799,544

(22) Filed: Mar. 5, 2001

(30) Foreign Application Priority Data
Aug. 24, 2000 (JP) 2000-253602

(51) Int. Cl. H04L 12/28; H04L 12/56

(52) U.S. Cl. 370/395.1; 370/466

(57) ABSTRACT

Disclosed is a transmitting apparatus for transmitting a fixed-length cell and a variable-length packet together in one network. A first IF portion of the transmitting apparatus attaches a header corresponding to the protocol of a mixed network to a variable-length packet which arrives from a packet network and transmits it to the mixed network. A second IF portion removes the cell header from a fixed-length cell which arrives from a fixed-length cell network, attaches a header corresponding to the protocol of the mixed network instead, and transmits it to the mixed length. A third IF portion judges whether a data with a header which arrives from the mixed network is a fixed-length cell or a variable-length packet, replaces the header of the mixed network by a cell header if the data is a fixed-length cell and transmits the data to a fixed-length cell network, while removing the header of the mixed network if the data is a variable-length packet, and transmits the data to a packet network.

### BACKGROUND OF THE INVENTION

The present invention relates to a method and an apparatus for transmitting a fixed-length cell such as an ATM cell and a variable-length packet such as an IP packet in a network. More particularly, the present invention relates to a method and an apparatus for efficiently transmitting a payload of a fixed-length cell together with a variable-length packet in a network on the basis of a layer 2 header which is provided for the ATM payload portion and the IP packet and which corresponds to the communication protocol in a mixed network.

A packet such as an IP (Internet Protocol) packet is transmitted in a LAN (Local Area Network) on the basis of an Ethernet and the like. In a WAN (Wide Area Network), on the other hand, an ATM (Asynchronous Transfer Mode) or a POS (Packet Over SONET) is generally utilized for transmission.

FIG. 30 is an explanatory view of a method of transmitting an IP packet by utilizing an ATM. The symbol PKT denotes an IP packet, which has a header PH and a transmit data DT. The header PH contains various information including a source address SA and a destination address DA. The IP packet PKT is divided into a multiplicity of ATM cells CL₁ to CLₙ, and a cell header HD is added to the head of each cell. The connection identifier (VPI/VCI) which is contained each of the cells CL₁ to CLₙ has the same value. In other words, in order to transfer an IP packet by utilizing an ATM, the IP packet is divided into a plurality of cells each of which is consisted of 48 bytes, and an ATM header is added to each cell before it is transmitted.

FIG. 31 is an explanatory view of a method of transmitting an IP packet by utilizing a POS. In order to transmit the IP packet in the POS, the packet PKT is mapped in the payload portion of the SONET. In FIG. 31, the IP packet PKT is mapped in the payload portion PL of a SONET STS-3 (OC-3). The frame of the SONET STS-3 (OC-3) is constituted by 9×270 bytes, wherein the first 9×9 bytes are a section overhead SOH and the rest is a path overhead POH and a payload PL in which the IP packet PKT is mapped.

In a conventional method of transmitting an IP packet by utilizing an ATM (FIG. 30), it is necessary to divide the packet into cells and provide an ATM cell header for each cell. In addition, it is also necessary to appropriately attach a padding for the adjustment of the length of a cell to the last cell constituting the packet. For this reason, the overhead becomes large, which inconveniently prevents an efficient use of a transmission band.

On the other hand, according to a conventional method of transmitting an IP packet by utilizing a POS (FIG. 31), the packet transmission efficiency is higher than that in the method utilizing an ATM. However, it is impossible to transfer non-packet information such as a sound by utilizing a strict QoS (Quality of Service) guarantee function in the ATM. Therefore, it is necessary to provide another transmission line in addition to the transmission line of POS for a user who wants to utilize the strict QoS guarantee function in the ATM, so that the charge on the carrier of the network increases.

As described above, it is impossible to realize an efficient transfer of an ATM cell and a packet at the same time in the prior art.

### SUMMARY OF THE INVENTION

Accordingly, it is an object of the present invention to eliminate the above-described problems in the related art, and to enable transmission of a fixed-length cell and a variable-length cell efficiently with these mixed in a network.

It is another object of the present invention to enable discrimination between a variable-length packet and a fixed-length cell or between a fragmented packet and a packet subjected to a padding processing by prescribing a maximum packet length and imparting a specific meaning to an LI (Length Indicator) code with a value which exceeds the maximum packet length.

It is still another object of the present invention to enable a judgment as to whether a data delivered from a mixed network is a fixed-length packet or a variable-length packet so as to approximately transmit the data to a cell network or a packet network, thereby enabling transmission among a cell network, a packet network and a mixed network.

It is a further object of the present invention to enable an efficient transmission in accordance with the characteristic of a fixed-length cell or a variable-length packet in the case where the transmission of a mixture of the fixed-length cell and the variable-length packet on the same transmission path is enabled by using a common protocol for making each of the payload of the fixed-length cell and the variable-length packet capsular.

It is a still further object of the present invention to enable the establishment of synchronization, that is, the recognition of the head of a cell or a variable-length packet by using the HEC (Header Error Correction) and the LI (Length Indicator) contained in the header in the case where the transmission of the fixed-length cell and the variable-length packet on the same transmission path is enabled by using a common protocol for making each of the payload of the fixed-length cell and the variable-length packet capsular.

It is a still further object of the present invention (1) to prevent a data which loops in a network for a long time from generating, (2) to enable a transmission of a packet which has a length exceeding a maximum packet length, and (3) to enable a transmission of a packet which has a length shorter than a minimum packet length.

To achieve these objects, in a first aspect of the present invention, there is provided a method of transmitting a fixed-length cell and a variable-length packet in one network comprising: (1) attaching a header referred to as a layer 2 header corresponding to communication protocol in a mixed network to a variable-length packet, and replacing a cell header of a fixed-length cell by layer 2 header corresponding to the communication protocol in the mixed network, and (2) transmitting the fixed-length cell and the variable-length packet in the mixed network on the basis of the layer 2 headers. In this manner, it is possible to transmit efficiently a fixed-length cell together with a variable-length packet on the same transmission.

In a second aspect of the present invention, there is provided a method of transmitting a cell and a packet further comprising: (3) judging whether data with a header which is delivered from the mixed network is a fixed-length cell or a variable-length packet, and (4) transmitting the fixed-length cell to a fixed-length cell network after replacing the layer 2 header in the mixed network by a cell header, and transmitting the variable-length packet to a packet network after removing the layer 2 header in the mixed network. In this manner, a transmitting apparatus is able to judge whether the data with a layer 2 header which arrives from the mixed network is a fixed-length cell or a variable-length packet, and transmit the data to a predetermined cell network or packet network, thereby enabling transmission among a cell network, a packet network and a mixed network.

In a third aspect of the present invention, there is provided a method of transmitting a cell and a packet comprising: (1) imparting information LI which indicates the payload length to the layer 2 header of a mixed network, (2) setting the LI value of the layer 2 header which is attached to a fixed-length cell at a value larger than a set value, and (3) setting the LI value of the layer 2 header which is attached to a variable-length packet at a value which is smaller than the set value and which indicates the actual payload length. In this manner, it is possible to compare the LI value of the data with the layer 2 header which arrives from the mixed network with the set value, and to judge whether the data is a fixed-length cell or a variable-length packet on the basis of the result of the comparison.

According to a method of transmitting a cell and a packet of the present invention, it is possible (1) to recognize the head (establishment of synchronization) of a cell/variable-length packet, (2) to prevent data which loops in the network for a long time from generating, (3) to transmit a packet which has a length exceeding a maximum packet length, and (4) to transmit a packet which has a length shorter than a minimum packet length.

Other features and advantages of the present invention will be apparent from the following description taken in conjunction with the accompanying drawings.

### BRIEF DESCRIPTION OF THE DRAWINGS

FIG. 1 shows the structure of a network;

FIGS. 2A and 2B show the conversion of a format (from an ATM network and an IP network to a mixed network);

FIGS. 3A and 3B show the conversion of a format (form a mixed network to an ATM network and an IP network);

FIG. 4 is a block diagram of the IF (interface) portion of a fixed-length cell;

FIGS. 5A to 5C are explanatory views of a tag;

FIG. 6 is a block diagram of the IF portion of a variable-length packet;

FIG. 7 is a block diagram of the mixed IF portion of a fixed-length cell and a variable-length packet;

FIG. 8 shows the structure of a header generator for a cell;

FIGS. 9A and 9B are explanatory views of a format of a mixed network;

FIG. 10 shows the structure of an in-device tag generator for a cell;

FIG. 11 shows the payload of a fixed-length cell with a tag;

FIG. 12 shows the structure of an in-device tag generator for a packet;

FIG. 13 shows a variable-length packet with a tag;

FIG. 14 is a block diagram of a first modification (presence or absence of an FCS) of the mixed IF portion of a fixed-length cell and a variable-length packet;

FIG. 15 is a block diagram a second modification (LI code point) of the mixed IF portion of a fixed-length cell and a variable-length packet;

FIG. 16 is a flow chart of a processing for discriminating between a fixed-length cell and a variable-length packet on the basis of an LI code point;

FIG. 17 is a flow chart of another processing for discriminating between a fixed-length cell and a variable-length packet on the basis of an LI code point;

FIG. 18 is a block diagram of a third modification (synchronization) of the mixed IF portion of a fixed-length cell and a variable-length packet;

FIG. 19 is an explanatory view of a mechanism of synchronization;

FIG. 20 is an explanatory view of the discrimination between a cell and a packet in the state in which synchronization has been established;

FIG. 21 is a block diagram of a fourth modification (TTL) of the mixed IF portion of a fixed-length cell and a variable-length packet;

FIG. 22 shows the structure of a header generator for a cell;

FIG. 23 is an explanatory view of the format of a mixed network;

FIG. 24 is a block diagram of a fifth modification (fragment) of the mixed IF portion of a fixed-length cell and a variable-length packet;

FIG. 25 shows the structure of a header generator for a packet in the fifth modification;

FIG. 26 is a block diagram of a sixth modification (padding) of the mixed IF portion of a fixed-length cell and a variable-length packet;

FIG. 27 shows the structure of a header generator for a packet in the sixth modification;

FIG. 28 is a block diagram of a seventh modification (ICMP) of the mixed IF portion of a fixed-length cell and a variable-length packet;

FIG. 29 shows an example of an ICMP message;

FIG. 30 shows the relationship between an IP packet and an ATM cell: and

FIG. 31 is an explanatory view of the format of a SONET OC-3 frame.

### DESCRIPTION OF THE PREFERRED EMBODIMENT

(A) Embodiment

(a) Schematic Explanation of the Present Invention

The present invention provides a transmitting method which enables a fixed-length cell such as an ATM cell and a variable-length packet such as an IP packet to be transmitted on the same transmission path. More specifically, in this method, a layer 2 (L2) header corresponding to the communication protocol in a mixed network is provided for an IP packet, while an L2 header is provided for the ATM payload in place of the cell header. The L2 header contains a function of detecting the border of a packet, discriminating between an IP packet and an ATM cell, identifying the connection of the layer 2, etc.

In order to find the border of a packet, it is necessary to find the L2 header from among the bit data train on the transmission path. In order to find the L2 header, (1) a CRC (Cyclic Redundancy Code) is attached to the L2 header on the transmission side of a packet or a cell, (2) the position where the result of the reverse operation of the CRC on the reception side of the packet or the cell is 0 is recognized as the head of the header, and (3) if the data is recognized as a variable-length packet, it is possible to obtain the next header position by using the length indicator (LI) in the header, while if the data is recognized as a fixed-length cell, it is possible to obtain the next header position by using a cell length (48 bytes in the case of an ATM cell) which is registered in advance.

In order to judge whether a received data is a variable-length packet (such as an IP packet) or a fixed-length cell (such as an ATM cell), the length indicator (LI) in the header is utilized. A maximum packet length of a variable-length packet is first defined. If the LI of a received data is not larger than the maximum packet length, the data is recognized as a variable-length packet. On the other hand, if the LI of a received data is larger than the maximum packet length, the data is recognized as a fixed-length cell or a cell or packet having a specific meaning depending upon the LI value.

The L2 header, which contains a connection ID of a layer 2, is able to identify the connection of a layer 2. That is, a fixed-length cell and a variable-length packet are transmitted in a mixed network by referring to the connection ID of a layer 2.

In addition, when a network is a ring network, the L2 header contains a Time-To-Live (TTL) in order to prevent a packet or a cell from limitlessly looping. In this case, the TTL is subtracted every time the packet or the cell passes a switch or a router, and when the TTL reaches a prescribed value, the packet or the cell is discarded.

(b) Structure of a Network in the Present Invention

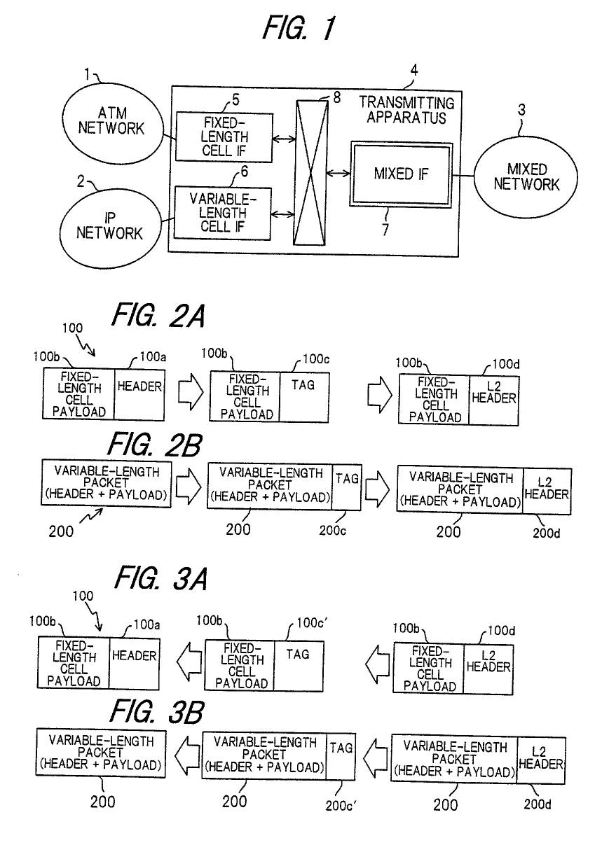

FIG. 1 shows the structure of a network, and FIGS. 2A, 2B, 3A and 3B are explanatory views of the conversion of a format in the present invention. In FIG. 1, the reference numeral 1 denotes an ATM network (fixed-length cell network) for transmitting an ATM cell which is a fixed-length cell, 2 an IP network (variable-length packet network) for transmitting an IP packet which is a variable-length packet, 3 a mixed network for transmitting a fixed-length cell together with a variable-length packet in one network, and 4 a transmitting apparatus provided on the boundary of each network. In the transmitting apparatus 4, the reference numeral 5 denotes a fixed-length cell IF portion interface portion serving as an interface between the ATM network 1 and the transmitting apparatus 4, 6 a variable-length packet IF portion serving as an interface between the IP network 2 and the transmitting apparatus 4, 7 a mixed IF portion of a fixed-length cell and a variable-length packet serving as an interface between the mixed network 3 and the transmitting apparatus 4, and 8 a switch.

The fixed-length cell IF portion 5 eliminates a cell header 100a from an ATM cell 100 which arrives from the ATM network 1, attaches a tag 100c for switching to a fixed-length cell payload 100b instead, and inputs the ATM cell 100 to the switch 8, as shown in FIG. 2A. The switch 8 switches the fixed-length cell payload 100b with a tag on the basis of the tag 100c, and inputs the cell 100 into the mixed IF portion 7. The mixed IF portion 7 eliminates the tag 100c, attaches a layer 2 (L2) header 100d to the fixed-length cell payload 100b instead, and transmits the fixed-length cell payload 100b to the mixed network 3. The mixed network 3 transmits the fixed-length cell payload to a predetermined destination address on the basis of the L2 header 10d.

The variable-length packet IF potion 6 attaches a tag 200c for switching to an IP packet (variable-length packet) 200 which reaches from the IP network 2, and inputs the IP packet 200 to the switch 8, as shown in FIG. 2B. The switch 8 switches the variable-length packet 200 with a tag on the basis of the tag 200c, and inputs the packet 200 into the mixed IF portion 7. The mixed IF portion 7 eliminates the tag 200c, attaches a L2 header 200d to the variable-length packet 200 instead, and transmits the variable-length packet 200 to the mixed network 3. The mixed network 3 transmits the variable-length packet 200 to a predetermined destination address on the basis of the L2 header 200d attached to the variable-length packet 200.

When the mixed IF portion 7 receives a data with an L2 header from the mixed network 3, it judges whether the data is a fixed-length cell payload or a variable-length packet by reference to the L2 header. If the data is a fixed-length cell payload, the mixed IF portion 7 eliminates the L2 header 100d, attaches a tag 100c′ instead, and inputs the data into the switch 8, as shown in FIG. 3A. The switch 8 switches the fixed-length cell payload 100b with a tag on the basis of the tag 100c′, and inputs the fixed-length cell payload 100b into the fixed-length cell IF portion 5. The fixed-length cell IF portion 5 eliminates the tag 100c′, attaches the cell header 100a of the ATM cell 100 to the fixed-length cell payload 100b instead, and sends it to the ATM network 1. The ATM network 1 transmits the ATM cell 1 to a predetermined destination address on the basis of the cell header 100a.

On the other hand, when the data received from the mixed network 3 is a variable-length packet (IP packet), the mixed IF portion 7 eliminates the L2 header 200d, attaches a tag 200c′ instead, and inputs the data into the switch 8, as shown in FIG. 3B. The switch 8 switches the variable-length packet 200 with a tag on the basis of the tag 200c′, and inputs it into the variable-length packet IF portion 6. The variable-length packet IF portion 6 eliminates the tag 200c′, and thereafter sends the IP packet 200 to the IP network 2. The IP network 2 transmits the IP packet 200 to a predetermined destination address on the basis of the IP header.

(c) Fixed Cell IF Portion

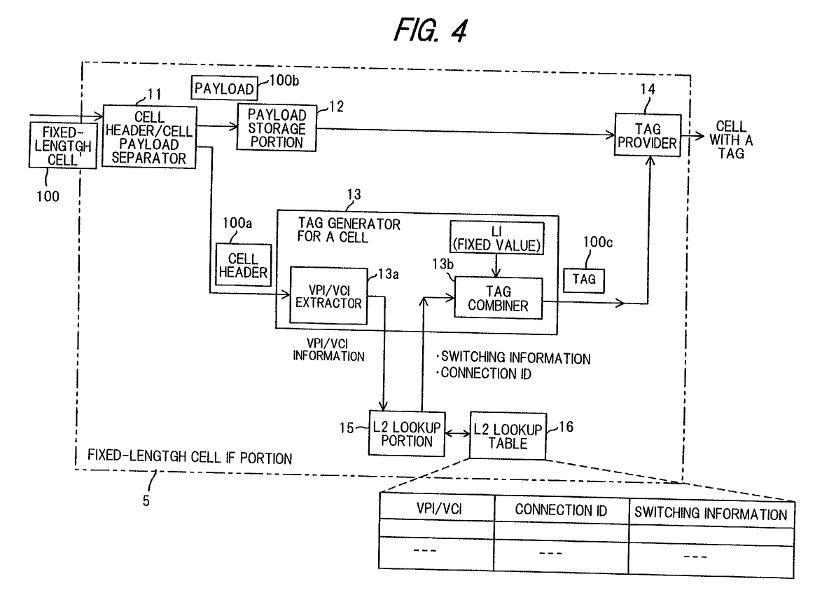

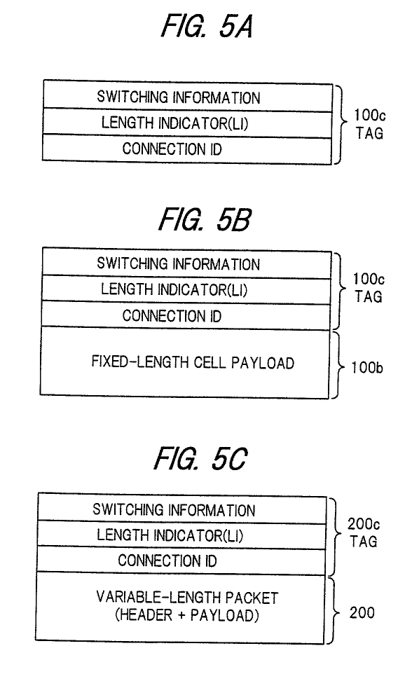

FIG. 4 shows the structure of the fixed-length cell IF portion 5. A cell header/payload separator 11 separates the ATM cell 100 of 53 bytes input from the ATM network 1 into the fixed-length cell payload 100b of 48 bytes and the cell header 100a of 5 bytes, and inputs them into a payload storage portion 12 and a tag generator 13 for a cell, respectively. The payload storage portion 12 stores the input fixed-length cell payload, and the tag generator 13 for a cell generates the tag 100c and inputs it into a tag provider 14. The tag 100c is composed of (1) output route information (switching information) for switching a cell to a predetermined route, (2) a length indicator LI (fixed value) indicating the payload length, and (3) a connection ID in the layer 2, as shown in FIG. 5A. The tag provider 14 attaches the input tag 100c to the fixed-length cell payload 100b which is stored in the payload storage portion 12 as shown in FIG. 5B, and transfers the fixed-length cell payload 100b to the switch 8 (FIG. 1). The switch 8 switches the fixed-length cell payload 100b to a predetermined route on the basis of the switching information.

The tag generator 13 for a cell generates the tag 100c for a cell in the following manner. A VPI/VCI extractor 13c extracts a VPI/VCI from the input cell header 100a, and inputs the VPI/VCI to an L2 lookup portion 15. Since the correspondences between (1) a connection ID and (2) switching information and the VPI/VCI are listed in an L2 lookup table 16, as shown in FIG. 4, the L2 lookup portion 15 obtains the connection ID and the switching information which correspond to the VPI/VCI, and inputs them to a tag combiner 13b. The tag combiner 13b generates the tag 100c by adding a length indicator LI (fixed value in the case of an ATM cell) to the input connection ID and switching information, and inputs the tag 100c into the tag provider 14.

(d) Variable-Length Packet IF Portion

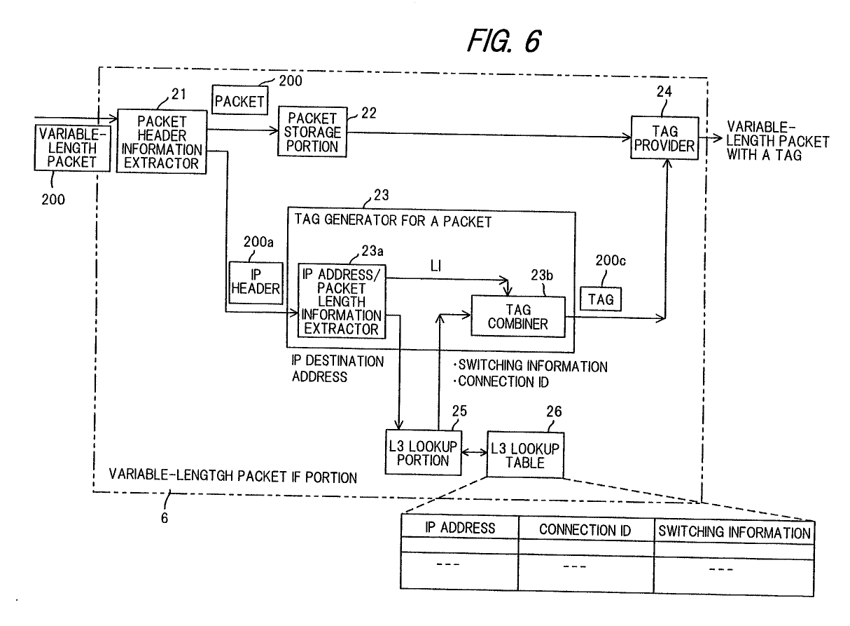

FIG. 6 shows the structure of the variable-length packet IF portion 6. A packet header information extractor 21 extracts the IP header 200a from the variable-length packet 200 input from the IP network 2, and inputs the extracted IP header 200a to a tag generator 23 for a packet and the variable-length packet 200 to a packet storage portion 22. The packet storage portion 22 stores the input variable-length packet 200, while the tag generator 23 for a packet generates the tag 200c and inputs it into a tag provider 24. The tag 200c has a similar structure as that of the tag 100c (FIG. 5A) which is attached to the fixed-length cell payload. The tag provider 24 attaches the tag 200c to the variable-length packet 200 which is stored in the packet storage portion 22 and transfers it to the switch 8 (FIG. 1). The switch 8 switches the variable-length packet 200 to a predetermined route on the basis of the switching information of the tag 200c.

The tag generator 23 for a packet generates the tag 200c in the following manner. An IP destination address/packet length information extractor 23a extracts an IP destination address and packet length information (LI) from the IP header 200a, and inputs them into a layer 3 (L3) lookup portion 25 and a tag combiner 23b, respectively. Since the correspondences between (1) a connection ID and (2) switching information and the IP destination address are listed in a L3 lookup table 26, as shown in FIG. 6, the L3 lookup portion 25 obtains the connection ID and the switching information which correspond to the IP destination address from the L3 lookup table 25, and inputs them into the tag combiner 23b. The tag combiner 23b generates the tag 200c by adding a length indicator LI to the input connection ID and switching information, and inputs the tag 200c into the tag provider 24.

(E) Mixed If Portion of a Mixture of a Fixed-Length Cell and a Variable-Length Packet

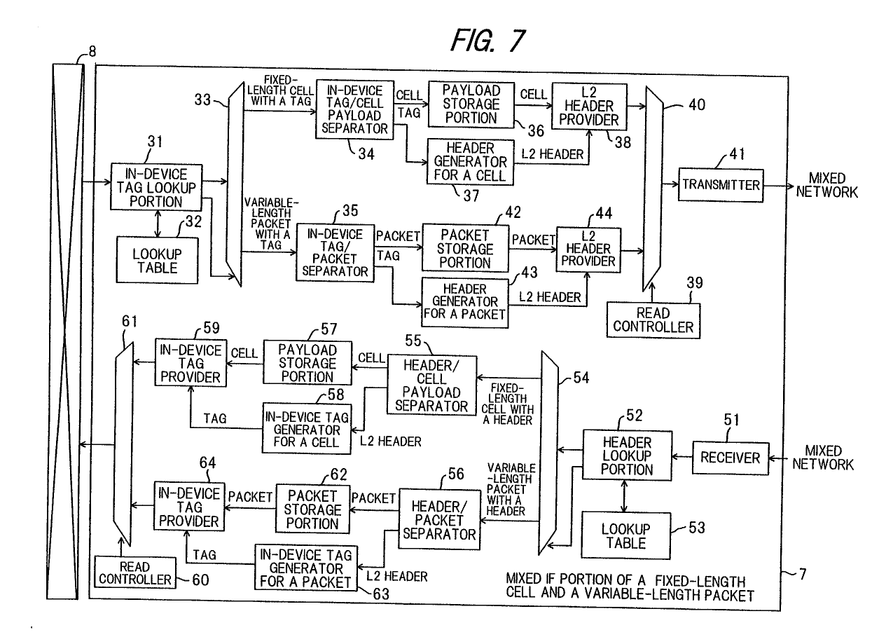

FIG. 7 shows the mixed IF portion 7 of a fixed-length cell and a variable-length packet. When a data with a tag is input from the switch 8, an in-device tag lookup portion 31 checks the tag so as to judge whether the data is a fixed-length cell or a variable-length packet. That is, since the correspondences between a tag (e.g., LI value) and a kind of data such as a fixed-length cell and a variable-length packet are listed in a lookup table 32, the in-device tag lookup portion 31 judges whether the input data is a fixed-length cell or a variable-length packet by referring to the tag and the lookup table 32. If the input data is a fixed-length cell, a gate portion 33 inputs the data into an in-device tag/cell payload separator 34, while if the input data is a variable-length packet, the gate portion 33 inputs the data into an in-device tag/packet separator 35.

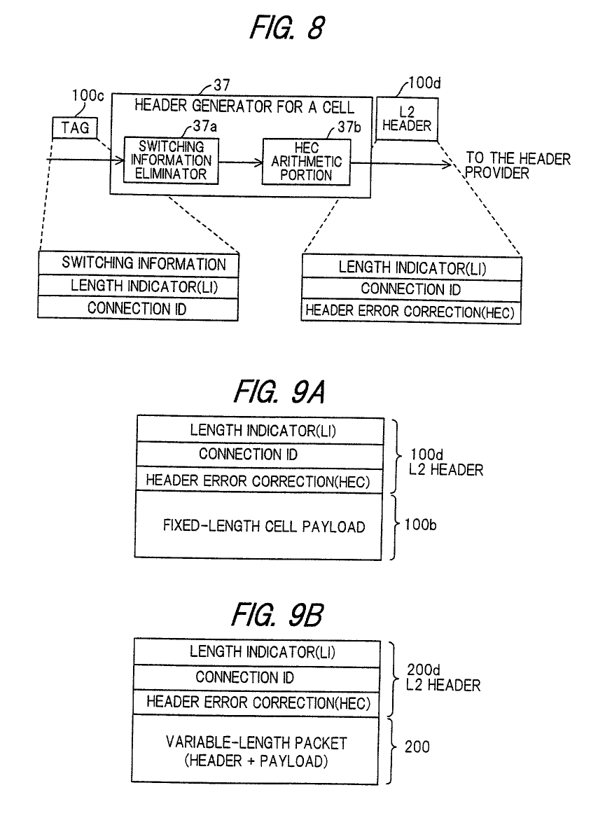

The in-device tag/cell payload separator 34 separates the input data (fixed-length cell with a tag) into the fixed-length cell payload and the tag, and inputs them into a payload storage portion 36 and a header generator 37 for a cell, respectively. The payload storage portion 36 stores the input fixed-length cell payload, and the header generator 37 for a cell generates a layer 2 (L2) header 10d which corresponds to the communication protocol in the mixed network 3 on the basis of the tag information. An L2 header provider 38 provides the L2 header 100d generated by the header generator 37 for the fixed-length cell payload input from the payload storage portion 36, and transmits the fixed-length cell payload with the L2 header 100d to the mixed network 3 via a gate 40 and a transmitter 41 under the control of a read controller 39. The header generator 37 for a cell, which has a structure shown in FIG. 8, generates and outputs the L2 header 100d in the following manner. A switching information eliminator 37a eliminates switching information from the input tag 100c and inputs the tag 100c into an HEC arithmetic portion 37b. The HEC arithmetic portion 37b executes a CRC operation on the LI and the connection ID, adds the CRC (Cyclic Redundancy Check) obtained to them as an HEC (Header Error Correction), thereby generating and outputting the L2 header 100d. As a result, the header provider 38 provides the L2 header 100d for the fixed-length cell payload 100b and outputs the fixed-length cell payload 100b with the L2 header 100d, as shown in FIG. 9A.

On the other hand, the in-device tag/packet separator 35 separates the input data (variable-length packet with a tag) into the variable-length packet and the tag, and inputs them into a packet storage portion 42 and a header generator 43 for a packet, respectively. The packet storage portion 42 stores the input variable-length packet, and the header generator 43 for a packet, which has the same structure as the header generator 37 for a cell, generates and outputs an L2 header. A header provider 44 provides the L2 header 200d generated by the header generator 43 for the input variable-length packet 200, as shown in FIG. 9B, and transmits the variable-length packet 200 with the L2 header 200d to the mixed network 3 via the gate 40 and the transmitter 41 under the control of the read controller 39.

In the above is described the structure for attaching the L2 headers 100d and 200d to the fixed-length cell 100 and the variable-length packet 200, respectively, and transmitting them to the mixed network 3. The structure for receiving a data with an L2 header will be described in the following.

When a receiver 51 receives a data with an L2 header from the mixed network 3, it inputs the data into a header lookup portion 52. The header lookup portion 52 judges whether the data is a fixed-length cell or a variable-length packet by checking the L2 header. That is, since the correspondences between a fixed-length cell and a variable-length packet and, for example, an LI value are listed in a header lookup table 53, the header lookup portion 52 judges whether the input data with an L2 header is a fixed-length cell or a variable-length packet by referring to the header lookup table 53. If the input data is a fixed-length cell with an L2 header, a gate portion 54 inputs the data into a header/cell payload separator 55, while if the input data is a variable-length packet, the gate portion 54 inputs the data into a header/packet separator 56.

The header/cell payload separator 55 separates the input data (fixed-length cell with an L2 header) into the fixed-length cell payload and the L2 header, and inputs them into a payload storage portion 57 and an in-device tag generator 58 for a cell, respectively. The payload storage portion 57 stores the input fixed-length cell payload, and the in-device tag generator 58 for a cell generates an in-device tag on the basis of the L2 header information.

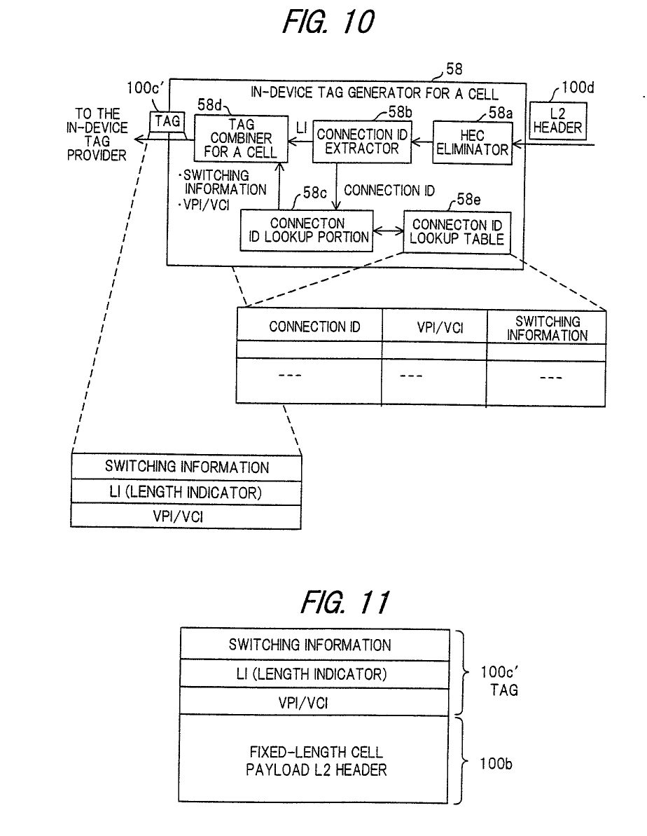

The in-device tag generator 58 for a cell, which has a structure shown in FIG. 10, generates and outputs the in-device tag in the following manner. An HEC information eliminator 58a eliminates the HEC information from the input L2 header 10d. A connection ID extractor 58b extracts the connection ID from the L2 header 100d, and inputs the connection ID into a connection ID lookup portion 58c, and the remaining header portion (LI) into a tag combiner 58d for a cell. Correspondences between (1) VPI/VCI and (2) switching information and a connection ID are listed in a connection ID lookup table 58e, as shown in FIG. 10. When the connection ID is input, the connection ID lookup portion 58c obtains the VPI/VCI and the switching information corresponding to the connection ID from the lookup table 58e, and inputs them into the tag combiner 58d for a cell. The tag combiner 58d for a cell adds a length indicator LI to the input VPI/VCI and switching information, thereby generating the tag 100c′ and inputs the tag 100c′ to an in-device tag provider 59. However, the LI in the in-device tag 100c′ is not essential but can be dispensed with.

The in-device tag provider 59 provides the tag 100c′ for the fixed-length cell payload 100b which is input from the payload storage portion 57, as shown in FIG. 11, and transmits the fixed-length cell payload 100b with the tag 100c to the switch 8 via a gate 61 under the control of a read controller 60. The switch 8 switches the fixed-length cell payload 100b with the tag 100c′ on the basis of the switching information contained in the tag 100c′, and inputs the payload 100b with the tag 100c′ into the predetermined fixed-length cell IF portion 5 (FIG. 1). The fixed-length cell IF portion 5 eliminates the switching information and the LI information (leaving the VPI/VCI) from the tag 100c′ of the fixed-length cell payload 100b′, adds necessary cell information, and transmits the fixed-length cell payload 100b to the ATM network 1.

On the other hand, the header/packet separator 56 separates the input data (variable-length packet with an L2 header) into the variable-length packet and the L2 header, and inputs them into a packet storage portion 62 and an in-device tag generator 63 for a packet, respectively. The packet storage portion 62 stores the input variable-length packet, and the in-device tag generator 63 for a packet generates an in-device tag on the basis of the L2 header information.

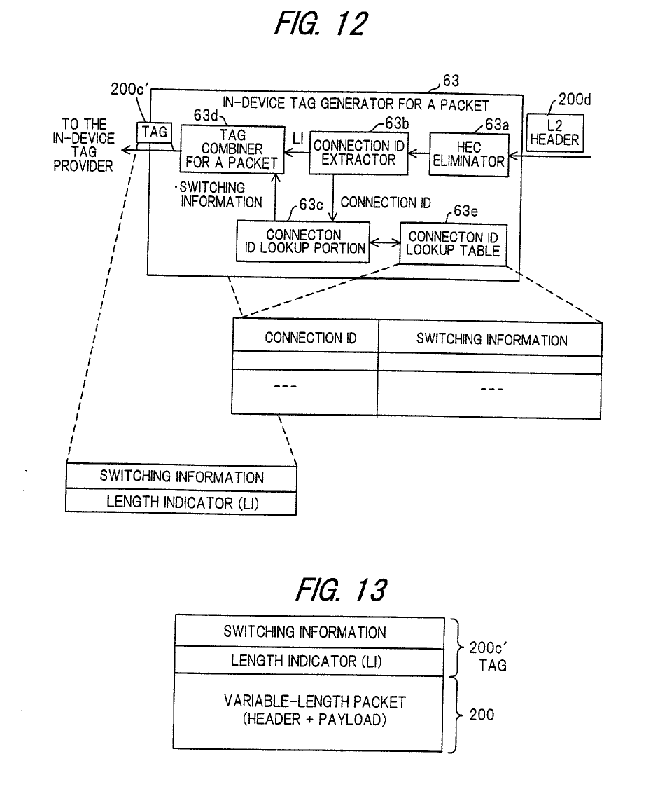

The in-device tag generator 63 for a packet, which has the structure shown in FIG. 12, generates and outputs an in-device tag. An HEC information eliminator 63a eliminates the HEC information from the input L2 header 200d. A connection ID extractor 63b extracts the connection ID from the L2 header 200d, and inputs the connection ID into a connection ID lookup portion 63c, and the remaining header portion (LI) into a tag combiner 63d for a packet. Correspondences between switching information and a connection ID are listed in a connection ID lookup table 63e, as shown in FIG. 12. When the connection ID is input, the connection ID lookup portion 63c obtains the switching information corresponding to the connection ID from the lookup table 63e, and inputs it into the tag combiner 63d for a packet. The tag combiner 63d for a packet adds a length indicator LI to the switching information, thereby generating the tag 200c′ and inputs the tag 200c′ to an in-device tag provider 64. However, the LI in the in-device tag 200c′ is not essential but can be dispensed with.

The in-device tag provider 64 provides the tag 200c′ for the variable-length packet 200, as shown in FIG. 13, and transmits the variable-length packet 200 with the tag 200c′ to the switch 8 via the gate 61 under the control of the read controller 60. The switch 8 switches the variable-length packet 200 with the tag 200c′ on the basis of the switching information contained in the tag 200c′, and inputs the variable-length packet 200 with the tag 200c′ into the predetermined variable-length packet IF portion 6 (FIG. 1). The variable-length packet IF portion 6 eliminates the tag from the variable-length packet 200, and transmits to the IP network 2.

According to the above-described embodiment, it is possible to efficiently transmit a fixed-length cell together with a variable-length packet on the same transmission path. In addition, transmission among a cell network, a packet network and a mixed network is enabled.

(B) First Modification

It is possible to increase the efficiency in the use of a transmission path by providing a bit error detection code such as an FCS (Frame Check Sequence) for a variable-length packet which is used mainly for data communication, thereby discarding a packet which has a bit error, while not providing an FCS for a fixed-length cell such as a sound which can tolerate a slight error.

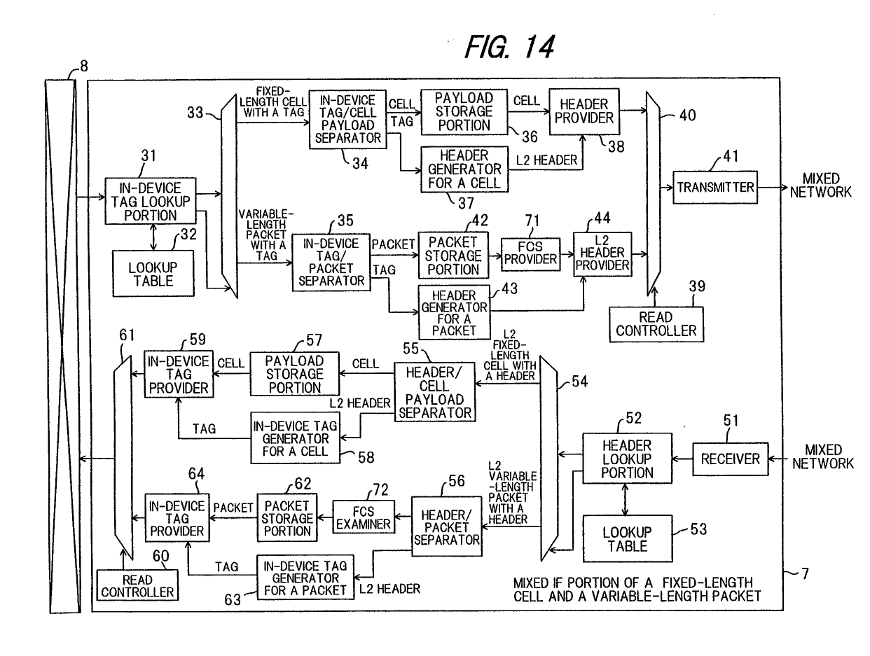

FIG. 14 shows an example of a modification of the mixed IF portion 7 for realizing the function of providing an FCS only for a variable-length packet. The same reference numerals are provided for the elements which are the same as those in the structure shown in FIG. 7. The modification shown in FIG. 14 is different from the embodiment shown in FIG. 7 in the following points:

(1) that an FCS provider 71 for calculating the FCS of a variable-length packet and attaching the FCS to the tail portion thereof is provided between the packet storage portion 42 and the header provider 44; and

(2) that an FCS examiner 72 for detecting a bit error by calculating the FCS of a variable-length packet and comparing the calculated FCS with the FCS attached to the tail portion of the variable-length packet is provided between the header/packet separator 56 and the packet storage portion 62.

When the mixed IF portion 7 shown in FIG. 14 transmits a data to the mixed network 3, if the data to be transmitted is a variable-length packet, the FCS provider 71 provides an FCS, which is a bit error detection code, for the packet. When the mixed IF portion 7 receives a data from the mixed network 3, if the input data is a variable-length packet with an L2 header, the FCS examiner 72 executes a bit error detection on the basis of the FCS, and if an error is detected, the packet is discarded.

As described above, according to the first modification, since a bit error detection code such as an FCS is provided for a variable-length packet so as to discard a packet which has a bit error, while no FCS is provided for a fixed-length cell, which can tolerate a slight bit error, it is possible to increase the efficiency in the use of a transmission path.

(C) Second Modification

The mixed IF portion 7 needs to judge whether the data with an L2 header which arrives from the mixed network is a fixed-length cell or a variable-length packet.

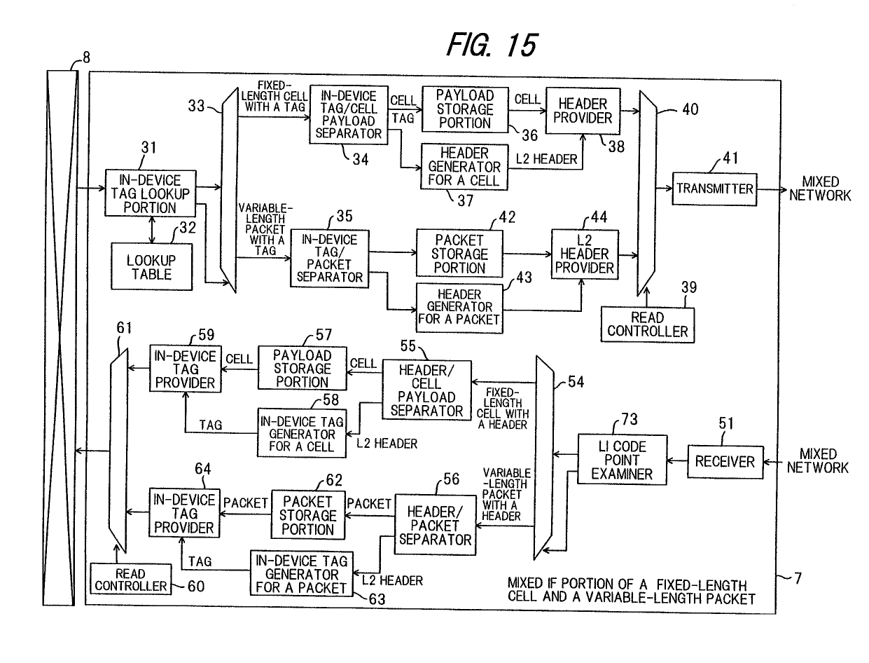

FIG. 15 shows a modification of the mixed IF portion 7 for judging whether the input data (data with an L2 header) is a fixed-length cell or a variable-length packet on the basis of an LI code point. The same reference numerals are provided for the elements which are the same as those in FIG. 7. The modification shown in FIG. 15 is different from the embodiment shown in FIG. 7 in that an LI code point examiner 73 is provided instead of the header lookup portion 52 and the lookup table 53. An LI indicates a payload length of a packet when the value is not more than a set value (e.g., a maximum packet length). When the LI exceeds the set value, it serves as an LI code point which has a specific meaning depending upon the value.

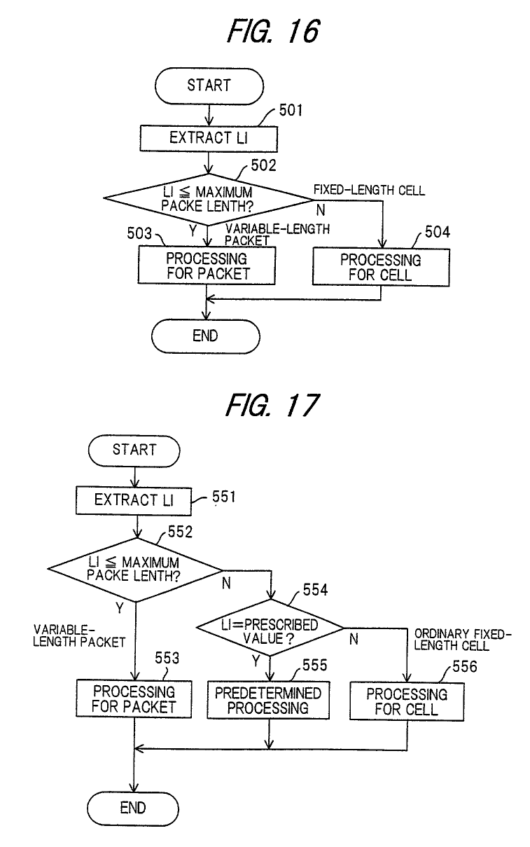

FIG. 16 is a flow chart of a processing of the LI code point examiner 73 for discriminating between a fixed-length cell and a variable-length packet on the basis of an LI code point when the LI value is larger than a set value, input data is recognized as a fixed-length cell.

When the LI code point examiner 73 receives a data with an L2 header, it extracts the LI from the L2 header (step 501), and judges whether the LI value is not more than a maximum packet length (step 502). If the LI value is not more than the maximum packet length, the LI code point examiner 73 judges that the data is a packet and executes a processing for a packet (step 503), while if the LI value exceeds the maximum packet length, the LI code point examiner 73 judges that the data is a fixed-length cell and executes a processing for a cell (step 504).

FIG. 17 is a flow chart of another processing of the LI code point examiner 73. In this processing, (1) when the LI value is a prescribed value which exceeds the maximum packet length, the data is judged to have a special meaning (e.g., OAM (Operation, Administration and Maintenance) cell), and (2) when the LI value exceeds the maximum packet length but it is not a prescribed value, it is judged to be an ordinary fixed-length cell.

When the LI code point examiner 73 receives a data with an L2 header, it extracts the LI from the L2 header (step 551) and judges whether or not the LI value is not more than the maximum packet length (step 552). If the LI value is not more than the maximum packet length, the LI code point examiner 73 judges that the data is a packet and executes a processing for a packet (step 553). If the LI value exceeds the maximum packet length, the LI code point examiner 73 judges whether or not the LI value is a prescribed value (step 554). If it is the prescribed value, the LI code point examiner 73 judges that the data is an OAM fixed-length cell, and executes a predetermined processing (step 555), while if it is not the prescribed value, the LI code point examiner 73 judges that the data is an ordinary fixed-length cell, and executes a processing for a cell (step 556).

Although a prescribed value is one in this example, it is possible to provide a plurality of prescribed values and provide a specific meaning for each of them. It is also possible to provide a prescribed value having a specific meaning for not only a cell but also a packet.

(D) Third Modification

It is necessary to shorten the L2 header as much as possible in order to heighten the transmission efficiency. For this reason, in a third modification, cell packet synchronization is enabled by using the HEC and the LI. The cell/packet synchronization means that a cell is separated from a packet by using a L2 header which is extracted from an input data train.

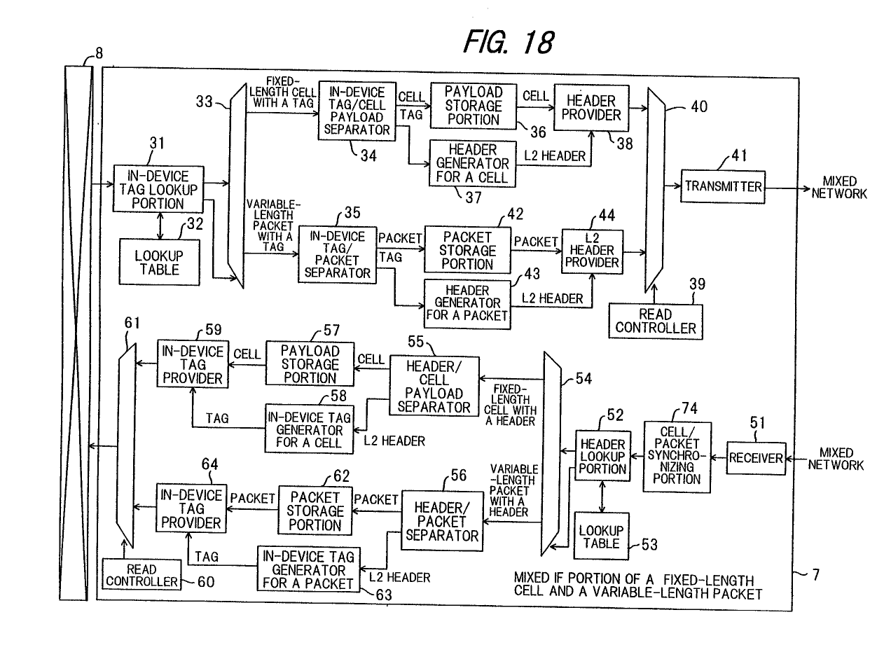

FIG. 18 shows a modification of the mixed IF portion 7 for realizing the function of cell/packet synchronization. The same reference numerals are provided for the elements which are the same as those shown in FIG. 7. The modification shown in FIG. 18 is different from the embodiment shown in FIG. 7 in that a cell/packet synchronizing portion 74 is provided between the receiver 51 and the header lookup portion 52. The L2 header contains (1) the LI (Length Indicator) for indicating a cell payload/packet length and (2) the HEC for indicating a CRC (Cyclic Redundancy Code). The cell/packet synchronizing portion74 is able to recognize the L2 header position by detecting the position where the result of the CRC calculation is correct. If the L2 header position is recognized, it is possible to extract the LI in the header. Therefore, the cell/packet synchronizing portion74 is able to detect the next header position on the basis of the LI, and thereby recognize the border between the cell and the packet. This state is called a synchronization-established state (referred to as “sync” hereinafter).

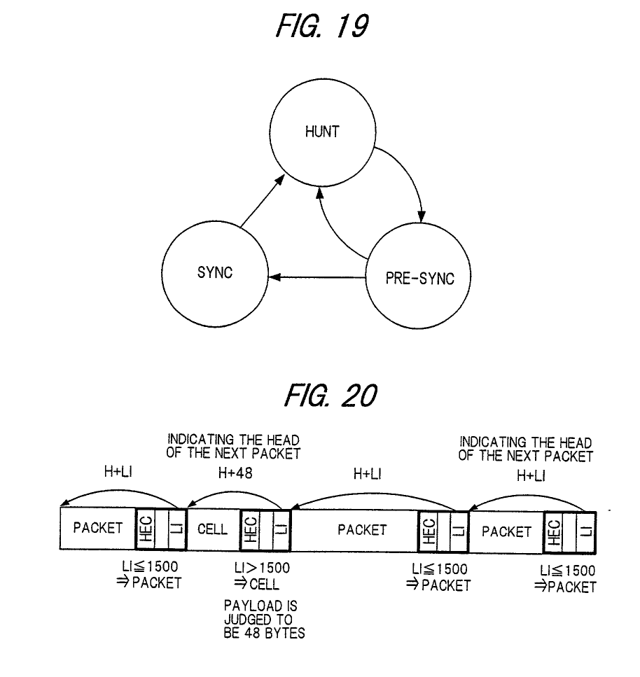

FIG. 19 is an explanatory view of a mechanism of establishment of synchronization. In the case of establishing synchronization from an asynchronous state referred to as hunting state Hunt, an HEC is calculated on the assumption that the received bit is a leading bit of the cell, and the result is compared with a next received data (virtual HEC). Thereafter, the HEC calculation is repeated while shifting the leading bit by 1 bit, and the position where the correct result of the calculation is obtained, that is, the point where the result of comparison agrees is searched for. If once the correct result of the calculation is obtained, it is judged that the cell synchronization is achieved (pre-synchronous state (Pre-sync)), and thereafter an HEC is calculated for every L1 byte. If the correct HEC value is obtained M times in succession, it is judged that the cell synchronization is ensured, and the Pre-sync state is shifted to a synchronization established state (sync). In this synchronization-established state, even if an error of the HEC occurs, it is not immediately judged to be an asynchronous state. It is not until an error occurs N times in succession that the state is judged to be asynchronous and shifted to a hunting state (Hunt).

FIG. 20 is an explanatory view of the separation of a cell and a packet in the synchronization-established state (sync). It is here assumed that a maximum packet length is 1500 bytes, and that the LI value of a fixed-length cell is larger than 1500. Therefore, if the LI (Length Indicator) is not more than 1500, a data with an L2 header is judged to be a variable-length packet, and the payload length is judged to be an LI byte. If the header length is assumed to be H bytes, it is judged that the head of the next packet comes after (H+LI) bytes from the head of the current packet.

If the LI exceeds 1500, the LI does not indicate a payload length but it is used as a code point. If the data with an L2 header is judges to be a fixed-length cell payload on the basis of the code point, it is judged that the payload length is 48 bytes (the payload of an ATM cell is 48 bytes). It is therefore judged that the head of the next packet comes after (H+48) bytes from the head of the current packet. Although it is assumed that the LI indicates a payload length in the above example, it is possible to separate a cell from a packet even if the LI indicates a length of (payload+header).

(E) Fourth Modification

In a fourth modification, a TTL (Time To Live) value is provided in an L2 header in order to prevent a data which loops in a network from generating, and every time a data passes through a transmitting apparatus in the mixed network, the time taken for a processing is subtracted from the TTL value, and when the TTL value becomes zero, the data is discarded.

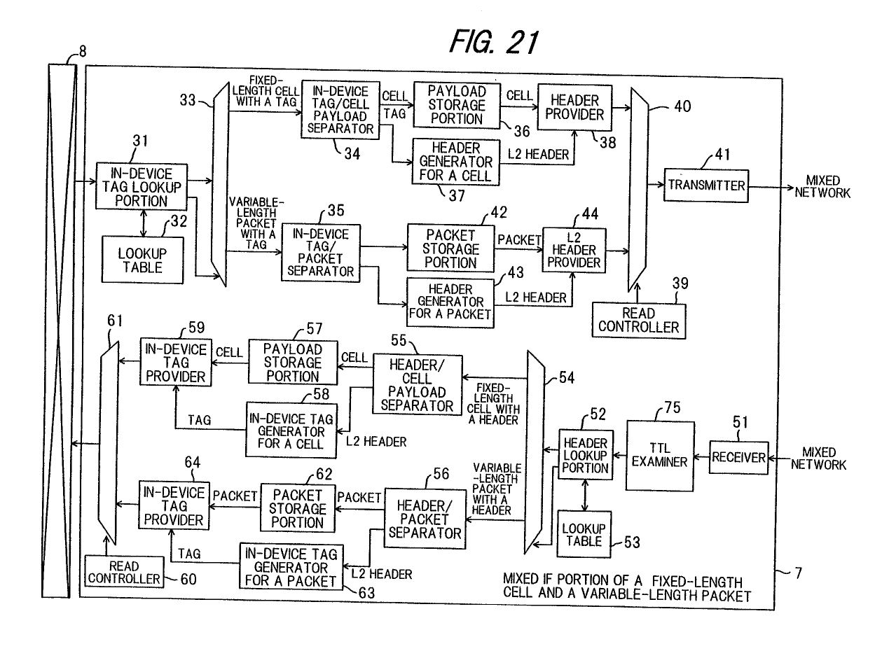

FIG. 21 shows a modification of the mixed IF portion 7 which is provided with a TTL examination function for discarding a data when the TTL value becomes zero. The same reference numerals are provided for the elements which are the same as those shown in FIG. 7. The modification shown in FIG. 21 is different from the embodiment shown in FIG. 7 in:

(1) that a TTL examiner 75 for discarding a data when TTL=0 is satisfied is provided;

(2) that the header generator 37 for a cell has a function of adding a TTL to the L2 header; and

(3) that the header generator 43 for a packet has a function of adding a TTL to the L2 header.

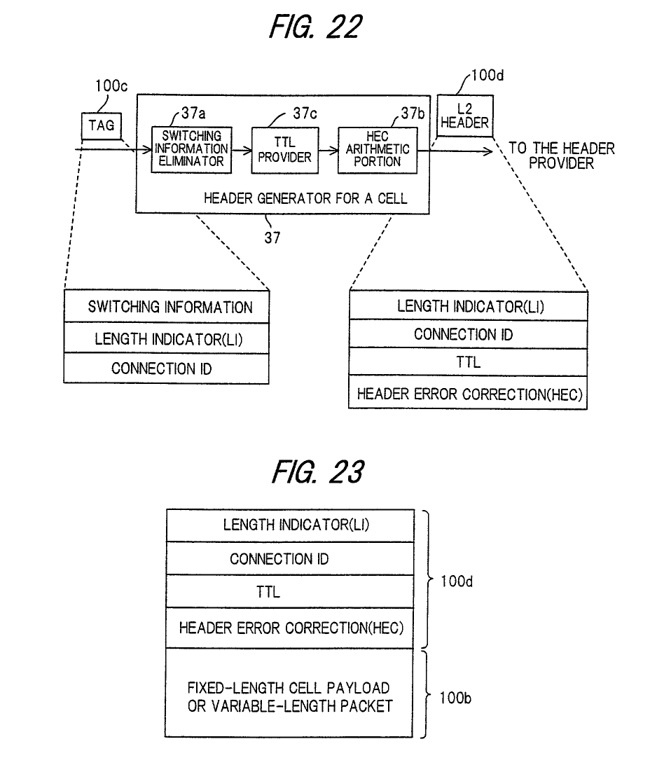

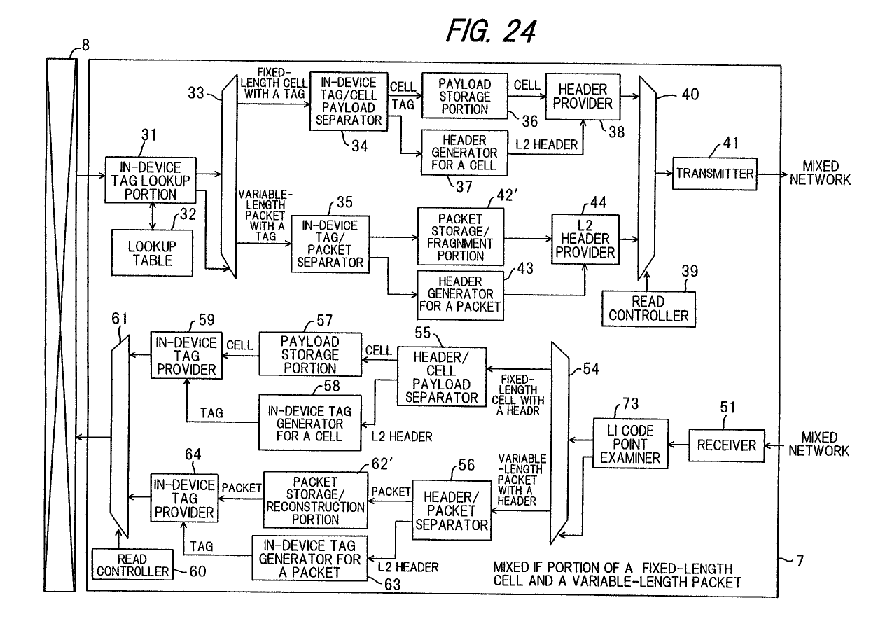

The header generator 37 for a cell includes a TTL provider 37c, as shown in FIG. 22, and attaches a TTL to a header. More specifically, the switching information eliminator 37a eliminates switching information from the input tag 100c, and the TTL provider 37c attaches a TTL and inputs the tag 100c to the HEC arithmetic portion 37b. The HEC arithmetic portion 37b executes a CRC operation on the input LI, connection ID, and TTL, adds the CRC obtained as the HEC, thereby generating and outputting the L2 header 100d. As a result, the header provider 38 provides the L2 header 100d having the TTL for the fixed-length cell payload 100b and outputs the thus-obtained fixed-length cell payload 100b, as shown in FIG. 23.

When the TTL examiner 75 receives a data with an L2 head from the mixed network 3, it checks whether or not the TTL value contained in the L2 header is 0, and discards the data if the TTL value is 0, while inputting the data to the header lookup portion 52 if the value is not 0.

(F) Fifth Modification

In this modification, in order to transmit a packet having a length exceeding a maximum packet length, the packet is divided into a plurality of packets.

FIG. 24 shows a modification of the mixed IF portion 7 which has a packet division/assembly function. The same reference numerals are provided for the elements which are the same as those of the second embodiment shown in FIG. 15. The modification shown in FIG. 24 is different from the second embodiment shown in FIG. 15 in the following points:

(1) that a packet storage/fragment portion 42′ is provided in place of the packet storage portion 42;

(2) that a packet storage/reconstruction portion 62′ is provided in place of the packet storage portion 62;

(3) that the header generator 43 for a packet adds information as to fragmentation to an L2 header, and instructs the packet storage/fragment portion 42′ to divide a packet; and

(4) that the in-device tag generator 63 for a packet instructs the packet storage/reconstruction portion 62′ to resconstruct an original packet when the input packet is recognized as a fragmented packet.

The header generator 43 for a packet has a structure shown in FIG. 25. A switching information eliminator 43a eliminates switching information from the tag 200c and inputs an LI and a connection ID into a fragment controller 43b. The fragment controller 43b checks whether the LI value is larger than a maximum packet length, and if it is smaller, the fragment controller 43b inputs the LI and the connection ID into an HEC arithmetic portion 43c as they are. The HEC arithmetic portion 43c executes an HEC operation on the input header (the LI and the connection ID), adds the HEC obtained to the header and inputs the header into the header provider 44 as the L2 header 200d (see FIG. 9B).

On the other hand, if the LI value is larger than the maximum packet length and it is not a prescribed value, that is, if it is not a fixed-length cell, the fragment controller 43b determines the number of fragments into which the packet is to be divided and the size of each fragment, instructs the packet storage/fragment portion 42′ to divide the packet, and a fragment information provider 43d to form and add fragment information.

The packet storage/fragment portion 42′ thereby divides the packet into the designated number of fragments each having the designated size. The fragment information provider 43d generates (1) a code point (specific LI value) indicating that the fragment is a piece of the divided packet, (2) a flag MF (More Fragment) indicating that the fragment is the last piece of the divided packet, (3) a sequence number indicating the order of division, and (4) an LI indicating the actual length of a fragmented packet, adds these items to the connection ID and inputs the header into the HEC arithmetic portion 43c. The HEC arithmetic portion calculates the HEC of the input header, adds the HEC to the header and inputs it into the header provider 44 as the L2 header 200d. The header provider 44 attaches the header to a fragmented packet output from the packet storage/fragment portion 42′ and transmits the fragmented packet to the mixed network 3.

When a data with an L2 header arrives from the mixed network 3, the LI code point examiner 73 judges whether the data is a fixed-length cell or a variable-length packet on the basis of the LI code point, and if it is a variable-length packet, the LI code point examiner 73 inputs the data with an L2 header into the header/packet separator 56. The header/packet separator 56 separates the data with an L2 header into the header and the packet, and the packet storage/reconstruction portion 62′ stores the packet. The in-device tag generator 63 for a packet examines the header so as to check whether or not the data is a fragmented packet, and if it is not a fragmented packet, the in-device tag generator 63 for a packet executes an ordinary tag generating processing. On the other hand, if the packet is a fragmented packet the in-device tag generator 63 for a packet instructs the packet storage/reconstruction portion 62′ to reconstruct an original packet using the fragmented packets on the basis of the fragment information. The original packet is thereby reconstructed, a tag is attached thereto by the in-device tag provider 64, and the original packet with the tag is sent to the switch 8.

(G) Sixth Modification

In this modification, a packet which has a length shorter than a minimum packet length is subjected to a padding processing so as to have a length longer than the minimum packet length before it is transmitted.

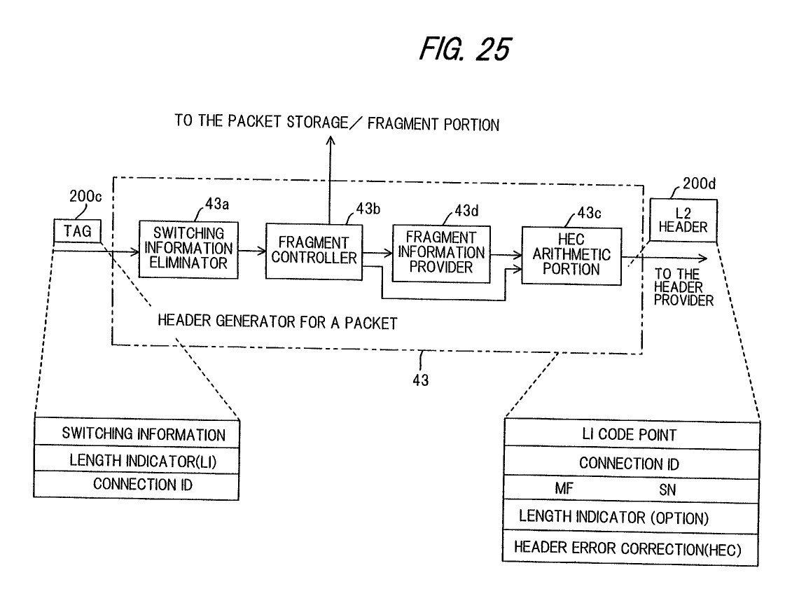

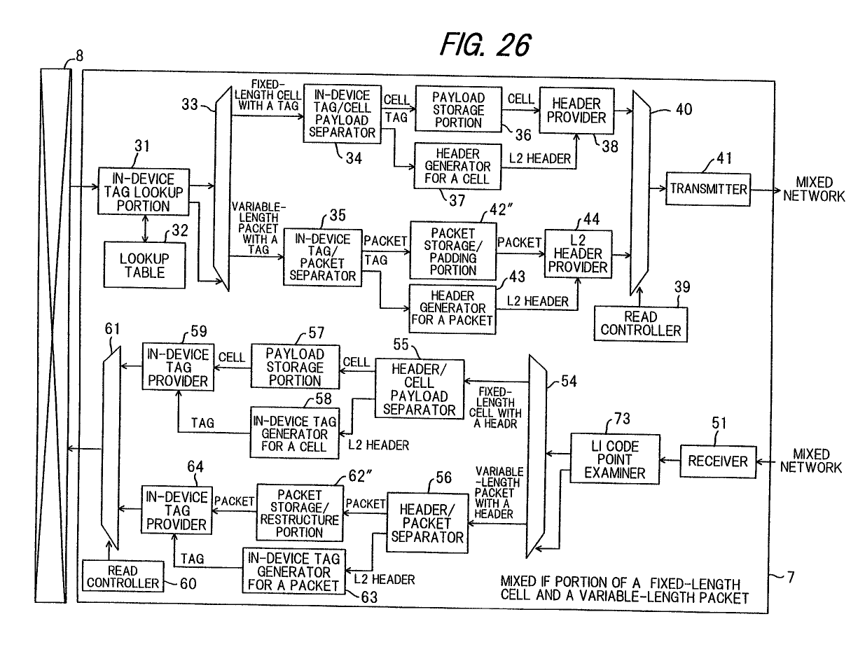

FIG. 26 shows a modification of the mixed IF portion 7 which has a padding function. The same reference numerals are provided for the elements which are the same as those of the second embodiment shown in FIG. 15. The modification shown in FIG. 26 is different from the second embodiment shown in FIG. 15 in the following points:

(1) that a packet storage/padding portion 42″ is provided in place of the packet storage portion 42;

(2) that a packet storage/reconstruction portion 62″ is provided in place of the packet storage portion 62;

(3) that the header generator 43 for a packet adds information as to padding to the L2 header, and instructs the packet storage/padding portion 42″ to execute a padding processing; and

(4) that the in-device tag generator 63 for a packet instructs the packet storage/reconstruction portion 62″ to reconstruct an original packet when the input packet is recognized as a packet subjected to a padding processing.

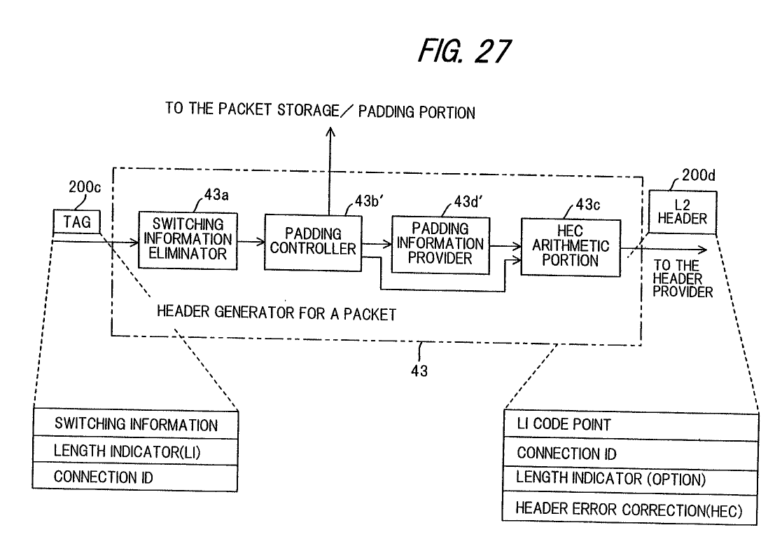

The header generator 43 for a packet has a structure shown in FIG. 27. The switching information eliminator 43a eliminates the switching information from the tag 200c, and inputs an LI and a connection ID to a padding controller 43b′. The padding controller 43b′ checks whether or not the LI value is smaller than a minimum packet length, and if it is larger, the padding controller 43b′ inputs the LI and the connection ID to the HEC arithmetic portion 43c as they are. The HEC arithmetic portion 43c executes an HEC operation on the input header (the LI and the connection ID), adds the HEC obtained to the header, and inputs the header to the header provider 44 as the L2 header 200d (see FIG. 9B).

On the other hand, if the LI value is smaller than the minimum packet length, the padding controller 43b′ instructs the packet storage/padding portion 42″ to execute a padding processing and a padding information provider 43d′ to form/attach padding information.

The packet storage/padding portion 42″ thereby adds a predetermined number of dummy bits to the packet so as to increase the packet length to a value not less than the minimum packet length. The padding information provider 43d′ forms (1) an LI code point (specific LI value) indicating that the packet has been subjected to a padding processing, and (2) an LI indicating the actual length of the packet subjected to a padding processing, adds these items to the connection ID, and inputs the connection ID into the HEC arithmetic portion 43c. The HEC arithmetic portion 43c calculates the HEC of the input header, adds the HEC obtained to the header, and inputs the header to the header provider 44 as the L2 header 200d. The header provider 44 attaches the header output from the header generator 43 for a packet to the packet which is output from the packet storage/padding portion 42″ and transmits the packet to the mixed network 3.

When a data with an L2 header arrives from the mixed portion 3, the LI code point examiner 73 judges whether the data is a fixed-length cell or a variable-length packet on the basis of the LI code point, and if it is a variable-length packet, the LI code point examiner inputs the data with an L2 header to the header/packet separator 56. The header/packet separator 56 separates the data with an L2 header into the header and the packet, and the packet storage/reconstruction portion 62″ stores the packet. The in-device tag generator 63 for a packet examines the header so as to check whether or not the packet has been subjected to a padding processing, and if the answer is in the negative, the tag generator 63 executes an ordinary tag generating processing. However, if the answer is in the affirmative and the packet is a padding packet, the tag generator 63 instructs the packet storage/reconstruction portion 62″ to reconstruct an original packet using the padding packet on the basis of the padding information, that is, to eliminate the dummy bits. In this manner, the original packet is restored, and the tag is added thereto by the in-device tag provider 64. The original packet with the tag is then transmitted to the switch 8.

(H) Seventh Modification

In this modification, when an input variable-length packet has a length exceeding a predetermined maximum packet length, the apparatus discards the packet so as to dispense with the necessity of fragmentation, and transmits an ICMP (Internet Control Message Protocol) to a transmission terminal so as to decrease the packet length.

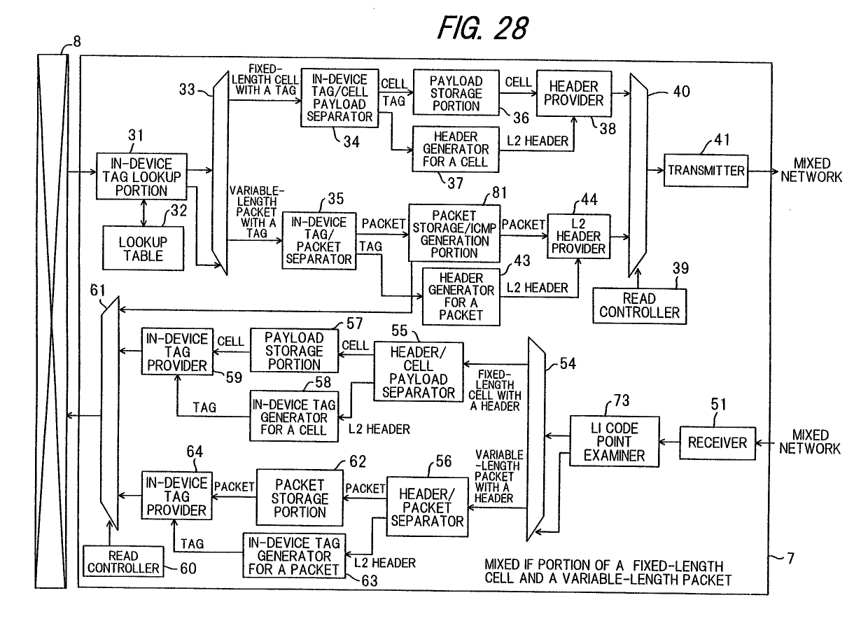

FIG. 28 shows a modification of the mixed IF portion 7 which has a function of transmitting an ICMP message. The same reference numerals are provided for the elements which are the same as those of the second embodiment shown in FIG. 15. The modification shown in FIG. 28 is different from the second embodiment shown in FIG. 15 in that a packet storage/ICMP generation portion 81 is provided in place of the packet storage portion 42.

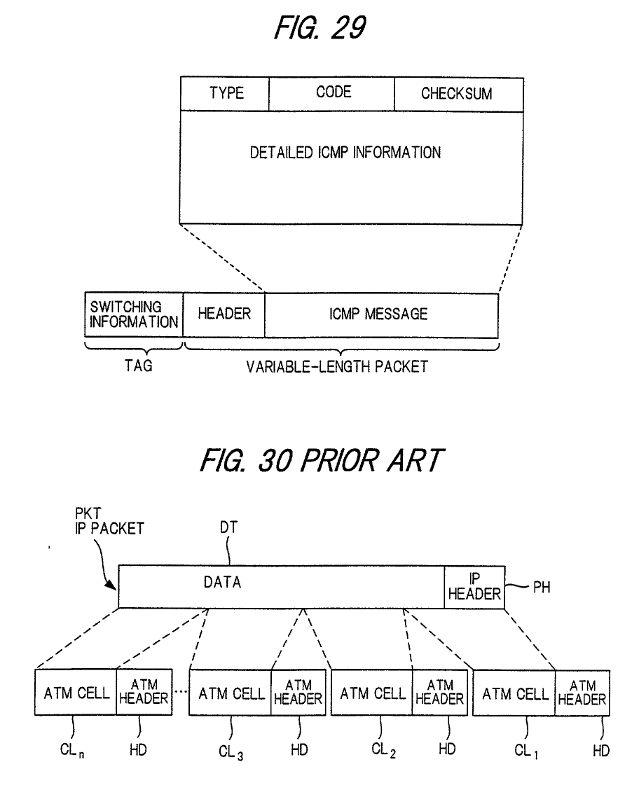

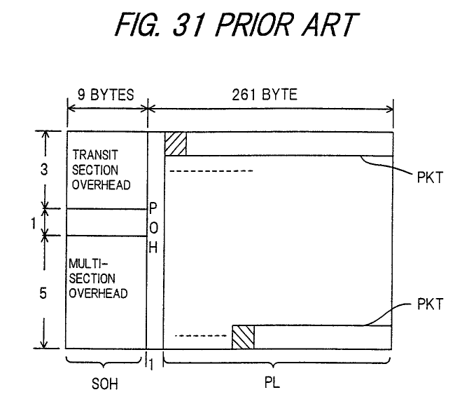

The packet storage/ICMP generation portion 81 checks whether or not the length of an input packet exceeds a predetermined maximum packet, and if the answer is in the affirmative, the packet storage/ICMP generation portion 81 discards the packet, generates an ICMP message, as shown in FIG. 29, and transmits it to a transmission terminal so as to instruct the transmission terminal to fragment the packet. The ICMP message is mapped in the payload of a variable-length packet. The message contains a code indicating the cause of the generation of the message, a checksum, detailed ICMP information, etc. A variable-length packet to which a tag (switching information) is attached and switched by the switch 8 is sent to an IP network after the tag is removed by the variable-length packet IF portion 6 (FIG. 1), and transmitted to the transmission terminal.

As described above, according to the present invention, if a data is a variable-length packet, a header (layer 2 header) corresponding to the communication protocol of a mixed network is attached, while if a data is a fixed-length cell, a cell header is removed and a layer 2 header of the mixed network is added instead, and the fixed-length cell and the variable-length packet are transmitted to the mixed network on the basis of the respective layer 2 headers. It is therefore possible to efficiently transmit a fixed-length cell together with a variable-length packet on the same transmission path.

According to the present invention, since judgment is made as to whether a data with a layer 2 header which arrives from the mixed network is a fixed-length cell or a variable-length packet, and if it is a fixed-length cell, the data is transmitted to a fixed-length cell network after the layer 2 header is replaced by a cell header, while if it is a variable-length packet, it is transmitted to a packet network after the layer 2 header is removed, the transmitting apparatus is able to transmit an input data to a predetermined cell network or packet network after it judges whether the data is a fixed-length cell or a variable-length packet. Thus, transmission of a data among a cell network, a packet network and a mixed network is enabled.

Moreover, according to the present invention, since a layer 2 header contains information LI indicating a packet length, and the LI value of the layer 2 header which is attached to a fixed-length cell is made larger than a maximum packet length, it is easy to judge whether a data with a layer 2 header which arrives from a mixed network is a fixed-length cell or a variable-length packet by comparing the LI value of the data with the maximum packet length. In addition, it is possible to impart a specific meaning to a data (cell or packet) containing an LI value by setting the LI value at a prescribed value larger than a maximum packet length.

Furthermore, according to the present invention, it is possible (1) to recognize the head of a fixed-length cell/variable-length packet (establishment of synchronization), (2) to prevent a data which loops in a network for a long time from generating, (3) to transmit a packet having a length which exceeds a maximum packet length, and (4) to transmit a packet having a length which is shorter than a minimum packet length, by providing various kinds of information for a layer 2 header.

As many apparently widely different embodiments of the present invention can be made without departing from the spirit and scope thereof, it is to be understood that the invention is not limited to the specific embodiments thereof except as defined in the depended claims.

What is claimed is:

1. A method of transmitting a fixed-length cell and a variable-length packet in one network comprising:
attaching a header corresponding to communication protocol in a mixed network in which both of a variable-length packet and a fixed-length cell are transmitted to a variable-length packet, while removing a cell header from a fixed-length cell and attaching a header corresponding to the communication protocol in the mixed network instead; and
transmitting said fixed-length cell and said variable-length packet in the mixed network on the basis of the respective headers.

2. A method of transmitting of a fixed-length cell and a variable-length packet in one network comprising:
attaching a header corresponding to the communication protocol in a mixed network in which both of a variable-length packet and a fixed-length cell are transmitted to a variable-length packet and transmitting said variable-length packet to the mixed network, when said variable-length packet arrives from a packet network;
removing a cell header from a fixed-length cell and adding a header corresponding to the communication protocol in the mixed network instead, and transmitting said fixed-length cell to the mixed network, when said fixed-length cell arrives from a fixed-length cell network;
judging whether data with a header is a fixed-length cell or a variable-length packet when said data arrives from the mixed network, and replacing the header of the mixed network by a cell header and transmitting said data to the fixed-length cell network if said data is a fixed-length cell, while removing the header of the mixed network and transmitting said data to the packet network if said data is a variable-length packet.

3. A method of transmitting a fixed-length cell and a variable-length packet in one network according to claim 2, further comprising:/
imparting information LI indicating a payload length to the header of said communication protocol, wherein said LI value of said header attached to said fixed-length cell is set at a larger value than a preset value, while said LI value of said header attached to said variable-length packet is set at a packet length not larger than said preset value; and
comparing said LI value of said data with a header which arrives from the mixed network with said preset value, and judging whether said data is a fixed-length cell or a variable-length packet on the basis of the result of the comparison.

4. A method of transmitting a fixed-length cell and a variable-length packet in one network according to claim 2, further comprising:
attaching a code for bit error detection to said variable-length packet, while not attaching a code for bit error detection to said fixed-length cell; and
executing a bit error detection processing by using said code for bit error detection when said variable-length packet with said header is received.

5. A method of transmitting a fixed-length cell and a variable-length packet in one network according to claim 2, further comprising:/
imparting LI (Length Indicator) information indicating a payload length and HEC (Header Error Correction) information which is a cyclic redundancy code for detecting an error in a header to the header of the mixed network; and
detecting, a header error by using said HEC information, and identifying the head of a cell/packet by using said HEC information and said LI information when a variable-length packet with a header or a fixed-length cell with a header is received.

6. A method of transmitting of a fixed-length cell and a variable-length packet in one network according to claim 2, further comprising:/
imparting TTL (Time To Live) information for restricting the time for which a data can exist in the mixed network to the header of the mixed network; and
checking, when a transmitting apparatus receives a data with a header whether or not said TTL value contained in said header is zero, and if said TTL value is zero, discarding data.

7. A method of transmitting a fixed-length cell and a variable-length packet in one network according to claim 3, wherein the range of said packet length is set in advance, and a specific meaning is imparted to said LI value exceeding said range.

8. A method of transmitting a fixed-length cell and a variable-length packet in one network according to claim 7, further comprising:
separating a packet having a length exceeding said preset range into a plurality of packets so that the length of each of the separated packets may satisfy said range;
setting said LI value of each of said separated packets at a value indicating that each packet is a fragmented packet; and
imparting information on fragmentation to said header.

9. A method of transmitting a fixed-length cell and a variable-length packet in one network according to claim 7, further comprising:
subjecting a packet having a length shorter than said preset range to a padding processing,
setting said LI value of said packet subjected to said padding processing at a value indicating that said packet has been subjected to said padding processing; and
imparting information on padding to said header.

10. A method of transmitting a fixed-length cell and a variable-length packet in one network according to claim 7, further comprising:/
sending a message that said packet length is too long to a transmission terminal when a received data is a packet having a length exceeding said preset range.

11. A transmitting apparatus for transmitting a fixed-length cell and a variable-length packet in one network comprising:
a first means for attaching a header corresponding to communication protocol of a mixed network to a variable-length packet which arrives from a packet network and transmitting said variable-length packet to said mixed network;
a second means for removing a cell header from a fixed-length cell which arrives from a fixed-length cell network, attaching a header corresponding to said communication protocol of said mixed network and transmitting said fixed-length cell to said mixed network; and
a third means for judging whether a data with the header of the mixed network which arrives from the mixed network is a fixed-length cell or a variable-length packet, and replacing the header of the mixed network by a cell header and transmitting said data to a fixed-length cell network if said data is a fixed-length cell, while removing said header of the mixed network and transmitting said data to a packet network if said data is a variable-length packet.

12. A transmitting apparatus according to claim 11, further comprising:
a switch for switching said variable-length packet and said fixed-length cell to the respective predetermined routes;
wherein said first means includes a variable-length packet IF portion interface portion for attaching a tag corresponding to a destination address to the variable-length packet, and a mixed IF portion for attaching a header corresponding to said communication protocol of the mixed network to said variable-length packet which is switched by said switch on the basis of said tag, and transmitting said variable-length packet to the mixed network;
said second means includes a fixed-length cell IF portion for attaching a tag corresponding to an connection ID to said fixed-length cell, and a mixed IF portion for attaching a header corresponding to the mixed network to said fixed-length cell which is switched by said switch on the basis of said tag, and transmitting said fixed-length cell to the mixed network; and
said third means includes a judging portion for judging whether said data with said header of the mixed network is a fixed-length cell or a variable-length packet, a fixed-length cell IF portion for replacing said header of the mixed network by said cell header and transmitting said fixed-length cell to said fixed-length cell network, and a variable-length packet IF portion for removing said header of the mixed network from said variable-length packet and transmitting said variable-length packet to said packet network.
